(19) United States
(12) Patent Application Publication
(10) Pub. No.: US 2007/0105073 A1
(43) Pub. Date: May 10, 2007

(54) System for treating disabilities such as dyslexia by enhancing holistic speech perception

(75) Inventors: Jose Roberto Kullok, Oakland, CA (US); Saul Kullok, Jerusalem (IL)

Correspondence Address: STERNE, KESSLER, GOLDSTEIN & FOX P.L.L.C., 1100 NEW YORK AVENUE, N.W., WASHINGTON, DC, 20005, US

(73) Assignee: Epoch Innovations, Ltd., Dublin (IE)

(21) Appl. No.: 11/642,600

(22) Filed: Dec. 21, 2006

Related U.S. Application Data
(63) Continuation of application No. 10/845,346, filed on May 14, 2004, now abandoned.
(60) Provisional application No. 60/533,212, filed on Dec. 31, 2003.

(51) Int. Cl. G09B 5/00

(52) U.S. Cl. 434/169

(57) ABSTRACT

The present invention relates to systems and methods for enhancing the holistic and temporal speech perception processes of a learning-impaired subject. A subject listens to a sound stimulus which induces the perception of verbal transformations. The subject records the verbal transformations which are then used to create further sound stimuli in the form of semantic-like phrases and an imaginary story. Exposure to the sound stimuli enhances holistic speech perception of the subject with cross-modal benefits to speech production, reading and writing. The present invention has application to a wide range of impairments including, Specific Language Impairment, language learning disabilities, dyslexia, autism, dementia and Alzheimer's.

### RELATED PATENTS

The applicants claim priority based on provisional application No. 60/533,212, “Apparatus, Method, And Computer Program To Promote Holistic Sensory Perception Of Receptive Language In A Subject By Listening To Verbal Transformations Of Words And/Or Phrases And/Or Sentences And/Or A Semantic-Like Composition Of Verbal Transformations In An Imaginary Story”, filed Dec. 31, 2003, the complete subject matter of which is incorporated herein by reference in its entirety.

This application is also related to the following patent and co-pending application, each of which are herein incorporated by reference in their entirety for all purposes: U.S. Pat. No. 6,644,976 titled Apparatus, Method And Computer Program Product To Produce Or Direct Movements In Synergic Timed Correlation With Physiological Activity issued Nov. 11, 2003 and co-pending U.S. patent application Ser. No. 10/235,838 titled Apparatus, Method And Computer Program Product To Facilitate Ordinary Visual Perception Via An Early Perceptual-Motor Extraction Of Relational Information From A Light Stimuli Array To Trigger An Overall Visual-Sensory Motor Integration In A Subject, filed Sep. 6, 2002.

### FIELD OF THE INVENTION

The present invention relates to systems and methods for enhancing the holistic and temporal speech perception processes of a learning-impaired subject by inducing the perception of verbal transformations. The present invention has application to a wide range of learning impairments including, Specific Language Impairment, language learning disabilities, dyslexia and autism. The present invention may also be utilized for language maintenance in subjects suffering from neurodegenerative diseases such as dementia and Alzheimer's.

### BACKGROUND OF THE INVENTION

It has been estimated that up to 10% of the population suffers from some kind of language learning disability. Language learning disabilities include Specific Language Impairment and dyslexia. At least 10% of the population suffers from dyslexia. Dyslexia occurs in people from all backgrounds and of all abilities, from people who cannot read to those with university degrees. Dyslexia is associated with a difficulty in learning reading, spelling and writing and may also be accompanied by difficulty with speech, numbers, short-term memory, sequencing, auditory and/or visual perception and other motor skills. Many of the difficulties can be traced to deficits in the phonological component of language. Although there is consensus that dyslexia is a specific learning disability that is neurobiological in origin the nature of the neurological problem and the manner by which it causes its diverse symptoms is still a topic of much research and controversy.

Dyslexia has its most significant impacts upon an individual's written language skills. Written language is a relative newcomer to human communication. Alphabetic reading and writing has only been around for a mere 5000 years. Humans had spoken language for perhaps a million years before that. Spoken language itself likely has its origins in protolanguage that goes back to the apes at least another million and a half years before that. As a consequence written language is a man-made structure built upon the a naturally created foundation of speech. The development of spoken language was obviously a crucial foundation for the development of written language. This is also the case in the individual where development of fluency in spoken language is a fundamental prerequisite of fluency in written language. Though many have tried to address dyslexia by shoring up written language skills, the inventors believe that real progress can only be made by addressing underlying problems with the foundation of holistic speech perception.

Speech perception is an interdisciplinary arena, a diverse and complex meeting place where physical, physiological, perceptual and cognitive processes intermingle and interact. Accordingly, physical acoustic properties of sound such as frequency, intensity and duration, are studied side by side with cognitive processes such as, cognition, attention and memory. All of the processes must interact correctly to translate and organize vibrations in the air into a comprehensible sound image of the world around us.

Research into speech perception has paralleled the reductionism of research into physics. In physics the study of elementary particles helps explain the physical properties of matter and the forces that hold it together. Phonemicists presumed that the phoneme, the smallest perceptual unit of speech, would also provide the best source of information about speech perception. They viewed oral language as a temporally ordered sequence of discrete phonemes that had to be segmented, ordered and then reassembled in the mind to achieve comprehension. However language has proved to be far more than the mere sum of its parts. The reductionist approach misses the synergies inherent in holistic auditory processes and has proved to be misleading rather than elucidating.

One example of phonemic theory is the work of Paula Tallal. Starting in the 1970's Tallal studied children with specific language impairments (SLI). SLI is a condition in which oral language skills are impaired while non-verbal ability is normal. Children with SLI cannot identify fast elements embedded in ongoing speech that have durations in the range of few tens of milliseconds. This was thought to be a critical time frame for speech perception because consonants last less than 40 milliseconds. Indeed Tallal and her collaborators produced evidence that SLI children demonstrated temporal deficits in the discrimination of stop consonants. They went on to produce evidence suggesting that language comprehension could be enhanced with acoustically modified speech. See, e.g., Tallal et al., “Developmental Aphasia: Impaired Rate Of Non-Verbal Processing As A Function Of Sensory Modality, Neuropsychologia, 11:389-398 (Pergamon Press 1973); Tallal et al., “Language Comprehension in Language-Learning Impaired Children Improved with Acoustically Modified Speech,” Science, 271:81-84 (1996).

The temporal processing impairment theory was then extrapolated by Tallal and others from the SLI population to the reading-impaired population. Tallal's analysis indicated that reading-impaired children also had a perceptual deficit impairing the rate at which perceptual information could be processed. Tallal showed that, when non-speech sounds were presented rapidly, reading-impaired children had a lower ability to properly sequence the stimuli than normal children. Tallal was also able to show that this reduction in sequencing ability correlated with observed deficits in phonemic awareness. Tallal advanced the hypothesis that reading-impaired and dyslexic children, like SLI children, have deficits in rapid auditory processing and temporal ordering which impairs the learning of phonological rules. See, Tallal, “Auditory-Temporal Perception, Phonics And Reading Disabilities In Children,” Brain and Language, 9:182-198 (1980); Tallal et al, “The Role Of Temporal Processing In Developmental Language-Based Learning Disorders: Research And Clinical Implications,” in “Foundations Of Reading Acquisition And Dyslexia: Implications For Early Intervention,” 49-66 (1997).

Building upon the temporal auditory processing deficit Tallal theorized that language-learning-impairments could be treated using slowed or stretched audio that decreased the speed of stimuli presentation. Tallal also theorized that this would facilitate the learning of phonological rules and remediate reading impairments such as dyslexia. Tallal and collaborators developed software implementing this strategy. The software is sold under the trade name Fast Forward I and II by Scientific Learning, Inc. The software is claimed to allow subjects with impaired temporal processing to exercise their brain to recognize and differentiate short duration acoustic events.

The Fast Forward software artificially emphasizes the phonetic structure of speech. The basic method is to recycle phonemes until they are distinguished in isolation, at a normal rate. This is accomplished by synthetically stretching speech and emphasizing isolated elements of speech to the point that they are perceptually distinguishable in their own right. The intended goal of the software is to retrain the brain by encouraging the subject to develop sufficient neurological connections for normal speed processing of speech. However, the program ambitiously aims to provide synthetic acoustic signals to the brain, such that the auditory perception resulting from synthetic phonemic training will be better than that resulting from exposure to normal human speech. No matter how fast your repeat “c” “a” “t” you never get to “cat”. Recent studies have shown that although the acoustically modified speech might provide some short-term enhancements to subjects, these enhancements are most likely due to the intense training and not on any specific problem addressed by the software. See, Studdert-Kennedy, “Deficits In Phoneme Awareness Do Not Arise From Failures In Rapid Auditory Processing,” Reading and Writing: An Interdisciplinary Journal 15: 4-14 (2002).

Tallal's analysis of her results, the resulting theories and remediation techniques have come under attack. Tallal made assumptions that similar mechanisms were involved in sequencing non-verbal sounds and speech sounds. However, several studies with dyslexic children have provided evidence that dyslexic children experience a deficit specific to decoding speech and not in more basic auditory processes. Furthermore, attempts to show that the deficit in processing rapidly changing auditory inputs causes the impairments in leaning of phonemic rules have generally failed. Mere correlation does not prove causation. See, Studdert-Kennedy et al., “Auditory Temporal Perception Deficits In The Reading-Impaired: A Critical Review Of The Evidence,” Psychonomic Bulletin and Review, 2:508-514 (1995); Studdert-Kennedy et al., “Speech Perception Deficits In Poor Readers: Auditory Processing Or Phonological Coding?” Journal of Experimental Child Psychology, 58:112-123 (1997); Studdert-Kennedy, “Deficits In Phoneme Awareness Do Not Arise From Failures In Rapid Auditory Processing,” Reading and Writing: An Interdisciplinary Journal 15: 4-14 (2002).

The paradigm of language as a temporally ordered sequence of discrete phonemes to be segmented, ordered and the reassembled has itself come under attack. In one example, researchers conducted a series of studies where subjects responded as soon as they heard a preset target syllables and phonemes in a sequence of nonsense syllables. Their experimental results on speech perception demonstrated that syllables are perceived faster than phonemes. In other words, syllables are perceived before their constituent phonemes are derived. They stated that: “The conclusion that follows from such considerations is that phonemes are primarily neither perceptual nor articulatory entities. Rather they are psychological entities of a nonsensory, nonmotor kind, related by complex rules to stimuli and to articulatory movements, but they are not a unique part of either of system of directly observable speech processes. In short phonemes are abstract.” Savin, H. B., & Bever, T. G., “The Nonperceptual Reality Of The Phoneme,” Journal of Verbal Learning and Verbal Behavior, 9:295-302 (1970). Other researchers have reached the same conclusion from different experiments; “The phonemes are a human invention, and unlike syllables they are not generated by neurologically distinct programs; physiologically they are ‘arbitrary’. Stein J. and Talcott J., “Impaired Neuronal Timing In Developmental Dyslexia—The Magnocellular Hypothesis,” Dyslexia 5: 59-77 (1999).

Further evidence of the nonperceptual reality of the phoneme comes from analysis of the mechanics of speech. Speech is a complex dynamic motor activity. Speech segments are necessarily produced in a co-articulated fashion because the mechanics and acoustics of making a particular speech sound are affected by the previous & subsequent sounds. However, co-articulation provides advantages to perception not disadvantages. Research has consistently shown that speech components are more quickly and accurately identified when presented in the context of the neighboring sounds. See, e.g., Strange et al., “Consonant Environment Specifies Vowel Identity,” Journal of the Acoustical Society of America, 60:213-224 (1976); Diehl et al., “Vowels As Islands Of Reliability,” Journal of Memory and Language, 26:564-573 (1987). The evidence from speech production clearly shows that co-articulation is an intrinsic property of natural speech. The mix of spectral and temporal information provides context required for proper perception. Analysis phoneme by phoneme ignores this context and would make perception difficult harder rather than easier. This is further evidence that phonemes are not natural elements of speech and their use as a synthetic tool impairs perception.

If phonetic segmentation and sequencing is essentially irrelevant to auditory perception as the research suggests how relevant is it to reading? Reading, necessarily involves a cross modal learning strategy—first holistically acquired speech perception and second proper integration with learned visual perception of written text. Can a common ground therefore be established between perceptual mechanisms extracting visual transient information from a written text and the perceptual mechanisms holistically extracting meaning from fluent speech? Speech perception is a foundational process for reading and the entire reading process must of necessity interact synergically with speech perception. Thus, it is of no surprise to the inventors that lexical compounds consisting of a word or words instead of single letters are in fact recognized as holistic entities in fluent reading.

Research more than a century old supports the theory that's holistic processes are at work in written language perception as they are in speech perception. Professor Cattell discovered a century ago that: “[W]hen single words were momentarily exposed, they were recognized as quickly as single letters, and indeed that it took longer to name letters than to name whole words, the exposures being made under conditions in which the times could be accurately measured. It was found that when sentences or phrases were exposed, they were either grasped as wholes or else scarcely any of the words or letters were read. This observation was strikingly confirmed in the writer's experiments in which sentences were momentarily exposed. Rarely were single letters read, even as forming the beginning or ends of words that were but partially recognized. The readings were of whole words, and almost always of words connected in some sense fashion Huey, E. B., “The Psychology And Pedagogy Of Reading,” pp. 72-73 (M.I.T. Press., Cambridge, Mass. 1968) (summarizing the research of J. M. Cattell published in 1908).

In more recent times, researchers performed experiments that demonstrated that when subjects were presented with visual stimuli such as “HEAR” and“AEHR” and asked to report whether the final letter was D or R subjects performed more accurately for meaningful words than for nonsense words. In a study of the reading rate of sentences as a function of the number of letters (including spaces) presented at once to the reader. The results showed that remote letters, as many as 14 to the right of fixation, although only barely seen, are still a factor to word recognition in reading. In another study comparing reaction times for recognizing individual letters and words the researcher concluded that: “Performance on words was consistently better than on single letters in all cases . . . . It seems appropriate to stop trying to explain away the phenomenon and, instead, to consider the implications for models of the human recognition system. The major conclusion to be drawn from the strength and persistence of the word superiority effect . . . is that word recognition cannot be analyzed into a set of independent letter recognition processes. There is an interaction among the letters such that the context of the other letters of a meaningful word improves recognition despite the control of letter redundancy. ” See, e.g., Rayner, K., & Bertera, J. H., “Reading Without A Fovea,” Science, 206:468-469 (1979); Miller, G. A., “The Science Of Words,” (Scientific American Library, N.Y., N.Y., 1991) (commenting on original work by G. M. Reicher); Wheeler, D. D., “Processes In Word Recognition,” Cognitive Psychology, 1:59-85 at 78 (1970).

Thus, despite the dominance of phonemic theory there is evidence that both fluent speech perception and fluent reading perception rely on similar holistic strategies. Evaluating dyslexia research from this perspective leads to the underlying theoretical ground that dyslexia is caused by verbal coding or phonological deficits. Indeed research suggests that phonological learning deficits in Dyslexics are the direct result from deficits in language-specific tasks demanding the association of verbal labels with visual and verbal stimuli rather than more general low level processes. See, e.g., Vellutino, F. R. “Dyslexia: Research and Theory,”.(MIT Press 1979); Vellutino et al., “Semantic And Phonological Coding In Poor And Normal Readers,” Journal of Experimental Child Psychology, 59:76-123 (1995); Vellutino et al., “Verbal Versus Non-Verbal Paired Associate Learning In Poor And Normal Readers,” Neuropsychologica, 13:75-82 (1975); Pinker, S., “The Language Instinct” (London: Penguin Press 1994).

It is the inventors' belief that neither speech perception nor fluent reading relies upon detection and ordering or phonemes. Moreover, the reading process relies heavily upon the process of speech perception. Fluent reading approaches the facility of fluent speech perception in that it relies upon the detection of whole words. Phonological awareness is not a perceptual process but a metacognitive analysis process that allows an individual to estimate spelling of words and decode new reading words. Although phonemes are a useful trick, their use impairs holistic perception and phonemic awareness cannot be scaled to achieve reading fluency. Teaching phonemic awareness in order to achieve fluency therefore misses the mark. An entirely different approach is required.

Researchers have studied holistic mechanisms of speech perception. One research tool is the investigation of two perceptual illusions: the restoration effect and the verbal transformations effect. The restoration effect is a perceptual illusion that seemingly restores speech sounds that have in fact been obliterated by a masking noise. When the masking of speech takes place, listeners apparently perceive the lost segments of sound as clearly as those actually present. Indeed, listeners are unable to perceive that the masking sound and the perceived word occurred at the same time or determine precisely when the masking event occurred. The listener not only believes that he hears the missing sound, but also, that the extraneous sound seems to occur during another portion of the sentence without interfering with the intelligibility of the speech. See, Warren, “Perceptual Restoration of Missing Speech Sounds,” Science 167:392-393 (1970).

The verbal transformation effect arises when the perceptual system is broken down. When listening passively to a recording of any repeating word or short sentence, a succession of illusory verbal transformations is perceived. Transformations range from one-phoneme alteration to drastic phonological distortions. Ambiguous syllables such as “ace,” when repeated without pause cause a subject to alternately feel he is hearing the words “say” and “ace.” Likewise uninterrupted repetition of “rest,” produces three plausible lexical interpretations (“rest,” “tress,” and “stress”). More dramatically listeners also report hearing other words involving less related to the physical sound of stimulus. For example, when presented with the word “truce,” listeners report hearing similar phonetically transformations such as “struce” and “truth,” and the pseudo-word “struth,” as well as unlike transformations, such as “Esther.” It has been hypothesized that the verbal transformation effect results when (1) auditory perceived forms are weakened via satiation due to uninterrupted iteration of the sound stimuli; (2) real-time criterion shifts reinforce the salience of competing alternative forms until one of these replaces the weakening form; (3) this new form undergoes satiation and is replaced by a new form and the cycle repeats. See, Warren et al., “An auditory analogue of the visual reversible figure,” American Journal of Psychology, 71:612-613(1958); Warren, “Verbal Transformation Effect and Auditory Perceptual Mechanisms,” Psychological Bulletin, 70:261-270 (1968).

The above auditory perception illusion validate the theory that perceptual detection-identification of speech is initiated at a phonetically complex level. Researchers who studied them rejected the existence of phonemes as neither necessary or possessing a perceptual status in speech recognition, “We suggest that it is misleading to consider acoustic sequences of brief items (such as phonemes in speech) as perceptual sequences, and that the models of speech perception involving analyses into components phonetic segments may be inappropriate.” See, Warren, “Identification Times For Phonemic Components Of Graded Complexity And For Spelling Of Speech,” Perception and Psychophysics, 9:345-349 (1971); Warren et al., “When Acoustic Sequences Are Not Perceptual Sequences: The Global Perception Of Auditory Patterns,” Perception and Psychophyiscs 54(1) 121-126 (1993).

Neither of these perceptual illusions can be explained by the phonemic paradigm. However, despite their utility as a tool to investigate auditory perception they have not been used as a tool to enhance auditory perception.

In view of the foregoing, it would be desirable to provide a system that promotes language learning without resorting to synthetic phonemic constructs.

It would further be desirable to provide a system that promotes language learning using holistic perceptual units that enable fluency using holistic processes.

It would still further be desirable to provide a system that promotes the self-organization of language processes in a language learning-impaired individual to enhance fluency in speech, auditory perception, reading and writing.

It would yet further be desirable to develop new, educative and leisure devices (e.g. computer software games, language teaching software, educational software etc.) which can deliver and expose the subject to new innovative auditory environments (computer, television, radio, films, CD, tape recorders, speaker phones, etc.) to facilitate a broad spectrum of much required holistic auditory perceptual skills in human every day life, in normal language acquisition, language learning disabilities, dyslexia, speech pathologies and neurodegenerative diseases.

### SUMMARY OF THE INVENTION

Accordingly it is an object of the present invention to provide a system that promotes language learning without resorting to synthetic phonemic constructs.

It is a further object of the invention to provide a system that promotes language learning using holistic perceptual units that enable fluency using holistic processes.

It is still further an object of the invention to provide a system that promotes the self-organization of language processes in a language learning-impaired individual to enhance fluency in speech, auditory perception, reading and writing.

It is yet further an object of the invention to develop new educative and leisure devices (e.g. computer software games, language teaching software, educational software etc.) which can deliver and expose the subject to new innovative auditory environments (computer, television, radio, films, CD, tape recorders, speaker phones, etc.) to facilitate a broad spectrum of much required holistic auditory perceptual skills in human every day life, in normal language acquisition, language learning disabilities, dyslexia, speech pathologies and neurodegenerative diseases.

These and other objects of the invention are accomplished in accordance with the principles of the invention by systems and methods for enhancing the holistic and temporal speech perception processes of a subject by inducing the perception and learning of novel verbal transformations by techniques that represent significant advances over the prior art.

The present invention rejects the ineffective artificial phonemic segmentation techniques of the prior art in order to promote the holistic perception of the basic receptive speech units conveyed by spoken language which are syllables, words and short sentences. It is at this naturally occurring organizational level that the methods of the present invention play a crucial role in promoting effortless spontaneous receptive language detection and comprehension without impairing fluency. The methods of the present invention promote holistic auditory perception of speech information thereby inducing the recognition of natural acoustic elements and triggering enhanced language skills in a subject. The present invention stands in stark contrast to classic phonemics or phonics methods that artificially partition language (expressive and receptive) into a sequence of discrete phoneme elements.

### DEFINITIONS

To aid the description of the invention, this section provides definitions of terms used herein.

“Auditory perception” refers to the process by which a subject converts sound to the feeling that the sound has a particular meaning. “Speech perception” refers to the special case of auditory perception in which the sound is a speech sound. Speech perception is the process by which a subject converts a speech sound to the feeling that the speech sound has a particular meaning.

“Phonetics” refers to the study of speech sounds. It is concerned with the actual nature of the sound and their production. The object of study of phonetics is called “phones”. Phones are actual speech sounds as uttered by human beings.

“Phonology” refers to the nature of sounds per se. Phonology describes the way sounds function within a given language. Stress and tone are also part of phonology.

“Phone” refers to an individual speech sound.

“Phoneme” refers to a member of the smallest distinctive group or class of phones in a language. The English Language is expressed by 42 phonemes.

“Phonotactic” refers to the set of allowed arrangements or sequences of speech sounds in a given language. A word beginning with the consonant cluster (zv), for example, violates the phonotactics of English, but not of Russian.

“Syntax” refers to the study of how words combine to form grammatical sentences. In other words, syntax focuses on the rules, or patterned relations, that govern the way the words in a sentence come together. Syntax concerns with how different words which are categorized as nouns, adjectives, verbs etc. are combined into clauses which in turn combine into sentences;

“Semantics” refers to the study of the literal meaning of words, and how these combine to form the literal meaning of sentences. In a specific sense, semantics is the study of “meaning”. The study of semantics is usually opposed to syntax, which refers to the formal way in which something is written.

“Prosodic” refers to the patterns of stress and intonation in a language.

The same speech sound can be produced in many different prosodic variations depending on the context. For example although the words are the same, the intonation of the words in the following sentences when read should be different—the different intonation is an indicator of meaning separate from the words themselves. Compare “Is there a fire in the theatre?” with “There's a fire in the theatre!”

“Holistic” refers to the emphasis of the importance of the indivisibility of the whole and the complex temporal interdependence of its parts.

“Sound” refers to vibrations transmitted through an elastic solid or a liquid or gas, with frequencies in the approximate range of 20 to 20,000 hertz, capable of being detected by human organs of hearing.

“Speech sounds” refers to those sounds that can be produced by the human voice. However, for the purposes of this patent speech sounds should included computer-synthesized renditions of the human voice.

“Verbal sounds” refers to phontactic speech sounds. Verbal sounds may be recorded by a performer or computer synthesized.

“Non-verbal sounds” refer to sounds that are not speech sounds. Non-verbal sounds include, but are not limited to, musical sounds, natural sounds, human non-speech sounds and noise sounds. Noise sounds may include any type of noise sound, including environmental noise, either man-made (i.e., sounds of machinery, motor noise, etc.) or non-man made (i.e., sounds of nature such as wind, rain, thunder, etc.). The stored noise segments may include any type of noise spectra, including Gaussian noise, pink noise, brown noise, white noise and red noise. Non-verbal sounds may be either naturally occurring or computer synthesized.

“Performer” refers to a human who recites speech sounds for recording. The individual may be any individual of any age, including an adult or child. For example, the individual may be a person unassociated with the subject. Alternatively, the individual may be associated with the subject, including a role model, a celebrity, a teacher, or a relative (e.g. parent or sibling) of the subject.

“Novel attention processing” refers to a technique used in the present invention to inhibit or delay habituation responses and enhance attention responses and orienting towards verbal stimuli.

“Word” refers to a sound or a combination of sounds, or its representation in writing or printing that symbolizes and communicates a meaning. A word may consist of a single morpheme or of a combination of morphemes.

“Phrase” refers to a part of speech that is a word or group of spoken words which the mind focuses on momentarily as a meaningful unit and which is preceded and followed by pauses. A written phrase is defined as a sequence of two or more words arranged in a grammatical construction and acting as a unit in the sentence.

“Sentence” refers to a linguistic form, a sequence of words arranged in a grammatical construction, which is not part of any larger construction and typically expresses an independent statement, inquiry, command, or the like.

“Syllable” refers to a segment of speech uttered with a single impulse or air pressure from the lungs, and consisting of one sound of relatively great sonority, with or without one or more subordinated sounds of relatively small sonority.

“Correlation” refers to the timing, modulation and/or coordination of a stimulus performed in a time varying or synchronized fashion with an intrinsically varying physiological activity in a target organ and/or physiological system.

“The temporal lobes” are an area of the brain critical to speech perception. There are two temporal lobes, one on each side of the brain located at about the level of the ears. The superior part of the temporal lobe includes an area where auditory signals from the cochlea first reach the cerebral cortex. This brain area-the primary auditory cortex, is involved in hearing. Adjacent areas in the superior, posterior and lateral parts of the temporal lobe are involved in high-level auditory processing such as speech. Wemicke's Area is a particular area in the posterior temporal lobe of the left hemisphere of the brain crucial for language recognition and comprehension. The dominant temporal lobe in the left cerebral hemisphere for right-handed people is of special importance in speech, language and reading. It is speculated that the temporal cortex, including Wemicke's area, possesses “sound images” of the words used to represent objects and concepts. In contrast, the non-dominant right temporal lobe is involved with prosodic information such as, verbal tones and intonations from others, rhythms and music.

The above definitions are provided in this section for the convenience of the reader, although it is noted that these terms are further described in other sections contained herein. Variations and/or extensions of the following definitions applicable to the present invention will be apparent to persons skilled in the relevant art(s) based at least in part on the teachings of the present invention which now continue.

The present invention uses repetition of auditory stimuli in order to cause a breakdown in auditory perception in the subject. The breakdown in auditory perception is used to create and reinforce connections between the auditory perception processes of the subject. The present invention is useful for treating language learning disabilities since language learning disabilities are correlated to auditory processing deficits and disrupted language detection and comprehension. Likewise and in particular, dyslexic children can be enormously aided by the present invention since dyslexics express deficits in written language skills hence finding it difficult to learn how to associate speech with visual forms (words). The present invention can also be applied to other language learning tasks such as by decreasing the time necessary to learn a new language.

In the first stage, the system of the present invention triggers the perception of verbal transformations in a subject (“Listener-User”) by playing a repeated verbal stimulus to the subject. The verbal stimulus in the first stage is an audio recording of a spoken word (“recorded word”). The recorded word may have been recorded by the Listener-User during the first stage or prerecorded by a performer. The triggering of the verbal transformation may be enhanced by novel attention processing of the verbal stimulus. Processing the stimulus includes a range of effects including masking portions of the repeated verbal stimulus with non-verbal sound. During or after the application of the verbal stimulus the subject records the verbal transformations perceived.

As indicated in the discussion above, verbal transformations are induced in the mind of the subject as a result of a breakdown in the process of auditory perception. The verbal transformation is illusory and cannot be directly recorded. However, the subject may make a “record” of the verbal transformation by for example, speaking and audio recording the perceived verbal transformation or typing the perceived verbal transformation onto a keyboard. We will for the purpose of this application refer to a spoken and recorded verbal transformation as a “recorded verbal transformation” or “RVT.” Alternatively the subject or an instructor may select the perceived verbal transformation from the prerecorded verbal stimuli. We will for the purpose of this application also refer to those verbal stimuli selected by the subject as “recorded verbal transformations” or “RVT.” The purpose of the first stage is to induce the perception of verbal transformations in the subject and generate one or more RVTs for utilization in the following stages. The Listener-User will typically cycle through the first stage at least several times before proceeding to the second or third stage unless the Listener-User has previously used the system and recorded a plurality of RVTs.

In a second stage, the complexity of the verbal stimuli is increased. Each second stage verbal stimulus comprises a plurality of recorded words and recorded verbal transformations arranged in a syntactically valid form. Essentially, the verbal stimuli will approximate a syntactically valid sentence or phrase. Ideally a verbal stimulus in the second stage comprises from 2 to 20 RVTs. Preferably the verbal stimulus comprises from 3 to 6 RVTs. However, the second stage verbal stimuli may comprise a mixture of recorded words and RVTs. During the second stage the verbal stimulus is again played to the subject in a repeating fashion. Again, the presentation of the verbal stimuli may be enhanced by novel attention processing techniques.

In a third stage, the complexity of the verbal stimuli is further increased. Again, a plurality of recorded words and recorded verbal transformations are arranged in a syntactically valid form. Essentially, the verbal stimuli will approximate a syntactically valid simple story. Ideally a verbal stimulus in the third stage comprises from 10 to 100 RVTs. However, the third stage verbal stimulus may comprise a mixture of recorded words and RVTs. During this third stage the verbal stimulus is again played to the subject in a repeating fashion. Again, the presentation of the stimuli may be enhanced by processing techniques.

The first, second and third stages operate together to use verbal transformations to stimulate the perception of novel auditory precepts in the subject in a holistic manner and promote the learning of those novel auditory precepts by placing them in semantic-like sentences and stories. Because the verbal transformations are created holistically from the mind of the subject they form in synergy with the subjects preexisting auditory perception mechanisms. The choice of recorded words, processing and timing is made so as to promote physiological orienting responses toward the novel precepts thus further aiding learning.

The teaching method of the present invention is most readily achieved using a combination of software and hardware built into a personal computer or computer network. The system must have means for storing a database of recorded verbal sounds and RVTs. The system must be able to play verbal stimuli to the subject through stereo headphones, preferably with the ability to supply different audio signals to the left ear and the right ear of the subject. The system must be able to record RVTs spoken by the subject during stage 1. The system preferably is capable of recording audio input from a microphone at the same time as playing audio. The system must also be able to apply processing such as masking to the recorded verbal sounds and RVTs. The system is preferably equipped with hardware for monitoring an intrinsically variable physiological cycle of the Listener-User and synchronizing or correlating aspects of the sound stimuli with that cycle.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram overview of a System 100, according to an embodiment of the present invention illustrating the relation between the various modules;

FIG. 2 is a block diagram of a Sound Storage Module 102 according to an embodiment of the present invention;

FIG. 3 is a block diagram of a First Sound Stimulus Module 104 according to an embodiment of the present invention;

FIG. 4 is a block diagram of a First Sound Listening Module 106;

FIG. 5 is a block diagram of an RVT Library Module 108 according to an embodiment of the present invention;

FIG. 6 is a block diagram of a Second Sound Stimulus Module 110 according to an embodiment of the present invention;

FIG. 7 is a block diagram of a computer system suitable for the operation of an embodiment of the present invention.

FIG. 8 is a block diagram of a Third Sound Stimulus Module 114 according to an embodiment of the present invention;

FIG. 9 is a table of suggested sight words suitable for use in the methods of the present invention with a subject of second grade reading level.

FIG. 10. is a block diagram of a Time Intervals Control and Regulation Module 120 according to an embodiment of the present invention.

The present invention will now be described with reference to the accompanying drawings. In the figures, like reference numbers indicate generally identical or functionally similar elements. Additionally, the digit(s) to the left of the right-most two digits of a reference number identify the drawing in which an element first appears.

### DETAILED DESCRIPTION OF THE INVENTION

The inventors' research into many correlated fields leads to the conclusion that phonological analysis of written language is a learned process that requires a solid foundation of holistic auditory perception. Hence, phonological awareness depends upon earlier development of holistic auditory perception mechanisms. The present invention enhances speech perception using systems and methods not previously taught in the art. As a result of the enhanced auditory perception processes, the audio-visual associative learning required for reading is facilitated. The system and methods disclosed have applications in a) receptive language detection and comprehension; b) phonological awareness of speech and written language; c) dyslexia; d) perceptual-motor speech dysphasia; and e) learning of foreign languages.

Fluent speech communication does not as the phonemic paradigm might suggest, occur in spite of a complex and variable mixing of spectral and temporal information in the sound signal. To the contrary, the dynamic and highly variant mix of spectral and temporal properties of speech is essential to holistic speech perception. The information content of speech is highly redundant. In other words, speech has a surplus of intelligibility. The redundancy is the key to the robustness of speech perception and a barrier to breaking down perception.

The verbal transformation effect represents a basic approach for penetrating the barriers of auditory perception for research. However, using verbal transformations to affect change in the auditory perception system requires control of a sensitive balance between habituation and attention. Novel and significant stimuli are optimal for promoting orienting and attention. Introducing a novel element into an unattended stream of stimuli can be used to trigger conscious or unconscious orienting that momentarily attracts attention to the stimuli. Thus, the present invention utilizes various “novel attention processing” techniques to inhibit or delay habituation and increase attention towards verbal sound stimuli and facilitate preferential processing of relevant information.

The present invention aims to recruit the entire nervous system in holistic speech perception of language. The present invention promotes a full integration of informational systems in the subject guarantying an autonomous regulation of receptive and expressive language so that speech perception and production evolves naturally towards the optimal rhythm of fluid speech. Hence, the methods of the present invention expose a subject to a wide spectrum of sensorial diverse auditory information in order to promote the holistic and spontaneous development of speech processing. The same processes trigger enhancements in the skills that form the foundation reading and writing.

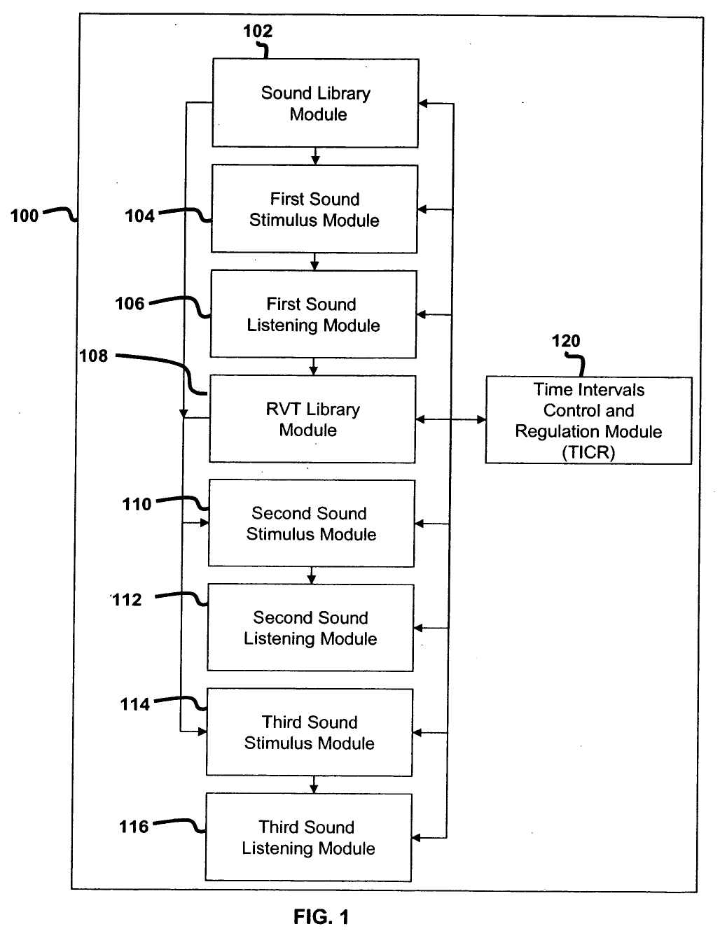

FIG. 1 shows a block diagram of a system 100, according to an embodiment of the present invention. As shown in FIG. 1, system 100 includes a Sound Library Module 102 which records and stores verbal and non-verbal sounds, a First Sound Stimulus Module 104 for preparing the first stage sound stimulus, a First Sound Listening Module 106 for playing the first stage sound stimulus to a user, an RVT Library Module 108 for recording verbal transformation perceived by the user during the first stage, a Second Sound Stimulus Module 110 for preparing the second stage sound stimulus, a Second Sound Listening Module 112 for playing the second stage sound stimulus to the user, a Third Sound Stimulus Module 114 for preparing the third stage sound stimulus, a Third Sound Listening Module 116 for playing the third stage sound stimulus to the user, and a Time Intervals Control And Regulation Module (TICR Module) 120 for controlling the timing of the playing of the sound stimuli to the user.

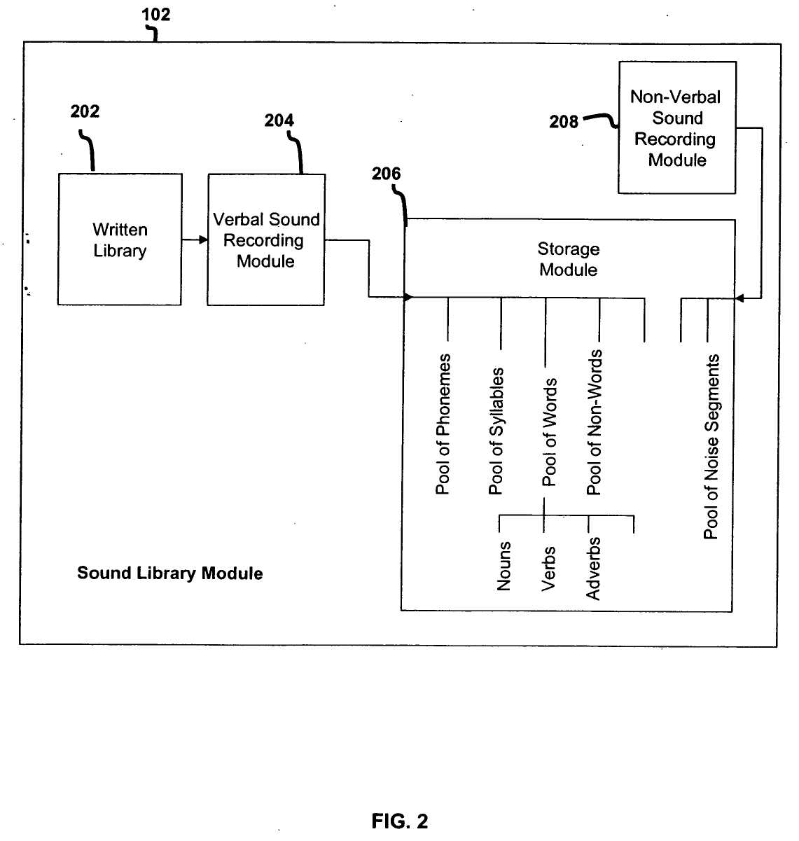

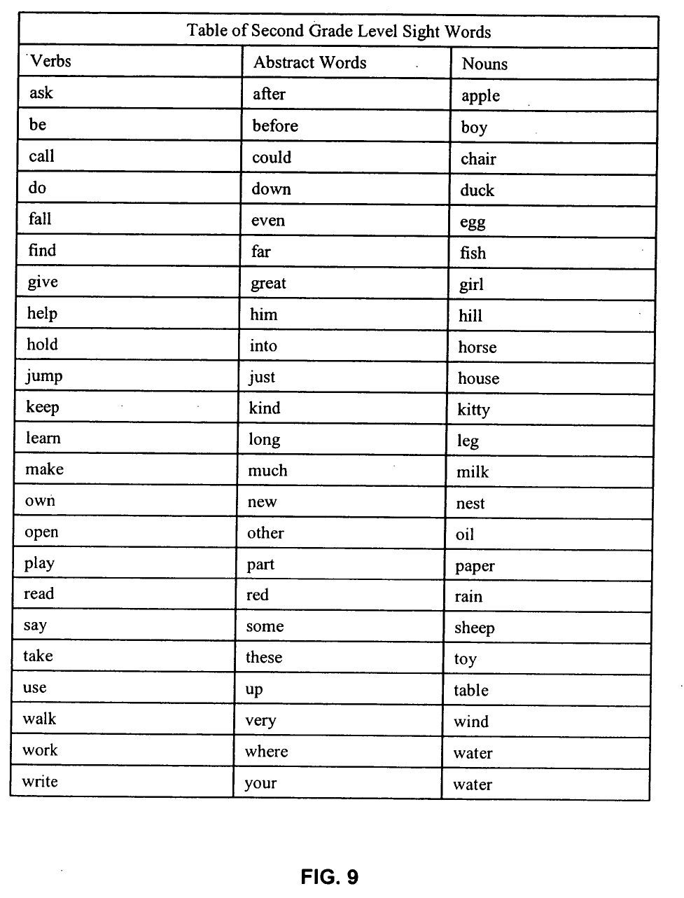

FIG. 2 shows a possible embodiment of Sound Library Module 102. Sound Library Module 102 records and stores a selection of sounds including recorded verbal sounds and recorded non-verbal sounds. As shown in FIG. 2 Sound Library Module 102 may include Non-verbal Sound Recording Module 208. Non-verbal Sound Recording Module 208 stores recordings of all types of non-verbal sounds which may be used by various components of the present invention. Non-verbal sounds may either be computer synthesized or recorded from a microphone. As further shown in FIG. 2, Sound Library Module 102 can include (or optionally receive) a Written Library Module 202, a Verbal Sound Recording Module 204, and a Storage Module 206. Written Library Module 202 includes a library of written material recorded in any tangible medium (e.g., paper, electronic). For example, Written Library Module 202 can include written representations of phones, vowels, phonemes, morphemes, syllables, monosyllables, polysyllables, words, combinations of words, and non-words. An example of sight words which could be included in Written Library Module 202 is given in the table of FIG. 9. Verbal Sound Recording Module 204 is used in conjunction with Written Library Module 202 to record verbal recitations of the written material of Written Library Module 202. In an embodiment, one or more performers are prompted to speak portions of the written material of Written Library Module 202. In a preferred embodiment a Listener-User is prompted to recite portions of the written material of Written Library Module 202. The verbal sounds of the performer or user may be recorded using any analog or digital recording device such as a microphone and stored using any type of recording medium. For the sake of convenience the verbal sounds recorded by the user will be referred to as user sounds. User sounds are defined as verbal sounds recorded by the current Listener-User of the system of the present invention. Alternatively, the written material of Written Library Module 202 can be read (e.g., when in a computer readable format) or scanned by a computer system, which may then synthesize the corresponding verbal sounds.

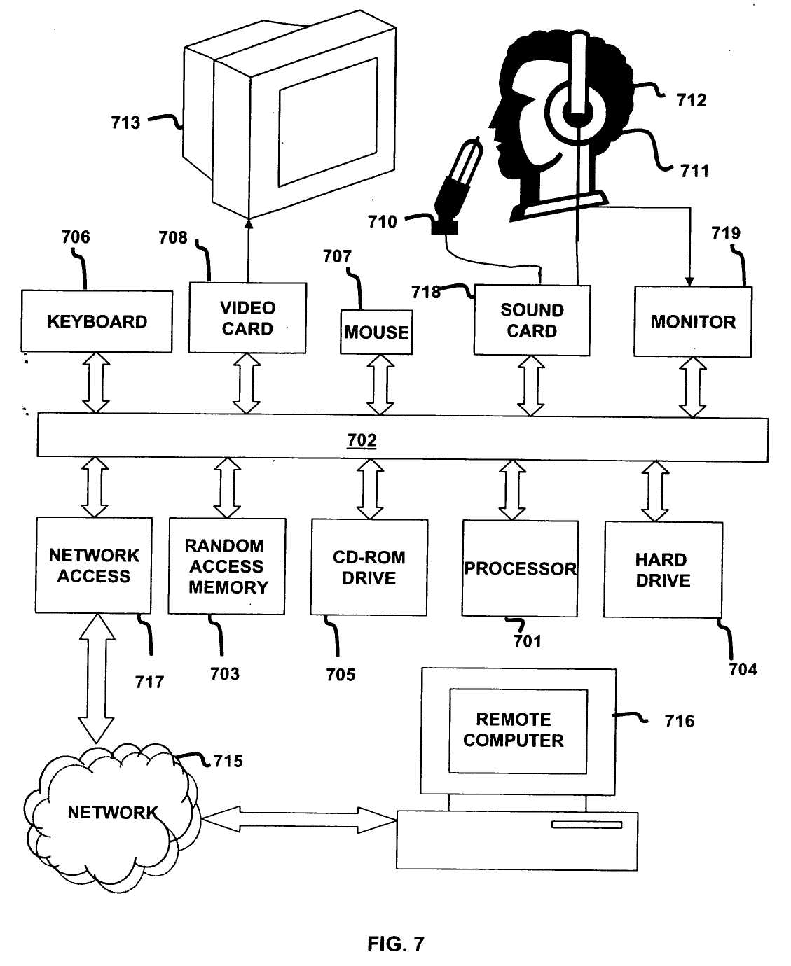

Storage Module 206 is used to store the verbal sounds recorded by Verbal Sound Recording Module 204 and non-verbal sounds of Non-verbal Sound Recording Module 208. In a preferred embodiment the verbal sounds and non-verbal sounds are stored in the form of a relational database. The database associates each recorded sound with data which specifies the properties of the sound. In one embodiment of a suitable database, the following sound data is included in each record: sound identification number; time of day recorded; circadian phase of performer; verbal or non-verbal; gender of performer; fundamental voice frequency of performer; identity of performer; sound duration; grammatical category (e.g. nouns, verbs, and adverbs for verbal); sound category (e.g. natural, noise, and man-made for non-verbal); sound text (for verbal); sound description (for non-verbal). The sound data stored in association with each recorded sound may be utilized during the selection of appropriate sounds for use with a particular Listener-User and during a particular stage of the method of the present invention. Storage Module 206 can be any storage medium or device type mentioned elsewhere herein, or otherwise known. In one embodiment of the present invention a database of verbal and non-verbal sounds is pre-recorded and stored on Storage Module 206. The database of verbal and non-verbal sounds may be recorded by a performer on a first computer and subsequently transferred to a second computer for use by the Listener-User. This transfer may be mediated by a network or by installation of files from suitable computer media. See e.g., FIG. 7. This permits sound stimuli for use with a particular Listener-User to be recorded at a remote location.

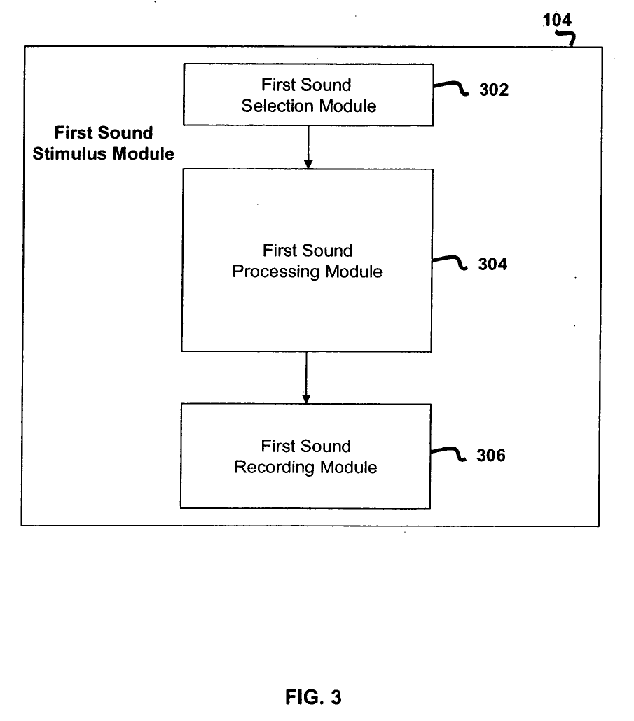

First Sound Stimulus Module 104 of FIG. 1 selects and retrieves recorded sounds from Sound Library Module 102. First Sound Stimulus Module 104 produces a repeating sequence of sounds. As shown in FIG. 1, and further described below, First Sound Stimulus Module 104 optionally is coupled to TICR Module 120, which can provide for timing control and regulation of the repeating sequence. First Sound Stimulus Module 104, as shown in the example embodiment of FIG. 3, may include a First Sound Selecting Module 302, a First Sound Processing Module 304, and a First Sound Recording Module 306.

First Sound Selecting Module 302 selects verbal sounds from First Sound Stimulus Module 104. First Sound Selecting Module 302 may also select one or more non-verbal sounds. For example, First Sound Selecting Module 302 may select the word “flame.” The selected word “flame” may be referred to as a “root” word. In the preferred embodiment the root word is a verbal sound recorded by the Listener-User. The particular word selected for inducing verbal transformations depends upon a multitude of factors. Sight words are preferred over non-sight words. Thus, the reading level and vocabulary of the Listener-User should be taken into account. Furthermore, verbs and abstract concept words are preferred over concrete nouns. For example, “learn” would be preferred over “book.” It is also important to select a range of root words from across the spectrum of a Listener-User vocabulary in order to maximize the advantages of the present invention. An example of sight words suitable for use as root words with a subject of second grade reading level is given in the table of FIG. 9. The table is broken down into verbs, abstract words and nouns.

Where it is not practical or convenient to use root words recorded by the Listener-User, it is desirable that root words have similar psycho-acoustic qualities to words spoken by the Listener-User. In general, the words are preferably recorded by somebody having the same age, gender, and regional accent as the Listener-User. Voices have a wide range of variation in spectrotemporal characteristics. The fundamental frequency of a voice, for example, averages approximately 120 Hz for an adult male, 250 Hz for an adult female and up to as high as 400 Hz for a child. The fundamental frequency of the Listener-Users voice can be readily ascertained using techniques known in the art. It is preferred that the Sound Library Module 102 contains a database of prerecorded verbal sounds recorded by male, female, adult and child voices across a range of fundamental frequencies. The database may be organized such that the age, gender, fundamental frequency (FFR) and other spectrotemporal statistical voice characteristics of the performer of the recorded words are associated with the recorded words. First Sound Selecting Module can then select a root word from the subset of the recorded verbal sounds in the database which closely approximates the voice of the Listener-User. For example, First Sound Selecting Module preferably selects a root word from the subset of the recorded verbal sounds in the database with fundamental frequencies within a quarter octave of the Listener-User's voice. Alternatively, or in addition, digital sound processing can be used to alter the fundamental frequency of the recorded words to more closely approximate the fundamental frequency of the Listener-User's voice using methods well known in the art. Where digital sound processing is used, the fundamental frequency of the recorded word can be adjusted to within an eight of an octave of the Listener-User's voice. The same effect may also be achieved by computer synthesizing root words with appropriate spectrotemporal qualities.

First Sound Processing Module 304 receives the selected sounds from First Sound Selecting Module 302, and processes the selected sounds. For example, First Sound Processing Module 304 creates a repeating sequence of sounds to be listened to by a user. First Sound Processing Module 304 may define the sequencing order of the sounds and a number of repetitions of each sound; In general periods of 30 seconds or more of a repeating verbal stimulus with 30 or more repetitions of a word are needed before verbal transformations are induced though the time and number or repetitions can be affected by the novel attention processing techniques described herein. For example, first stage processing 304 may use the selected root word “flame” in a repeating sequence, where “flame” is to be repeated twice a second 300 times over a total time of two and a half minutes. Furthermore, in an embodiment, First Sound Processing Module 304 may use one or more selected non-verbal sounds and one of more sound manipulation processes to “novel attention process” the sequence of repeating verbal sounds as further described below. In an alternative embodiment, the processed sounds may be synthesized into a verbal recitation by a computer or other voice synthesis mechanism. First Sound Processing Module processes the sounds to prepare a first stage sound stimulus.

First Sound Recording Module 306 receives the first stage sound stimulus from First Sound Processing Module 304, and records the first stage sound stimulus. In a preferred embodiment First Sound Recording Module 306 records the first stage sound stimulus in random access memory in order to enable rapid play back by First Sound Listening Module 106. However First Sound Recording Module may use other suitable sound recording media.

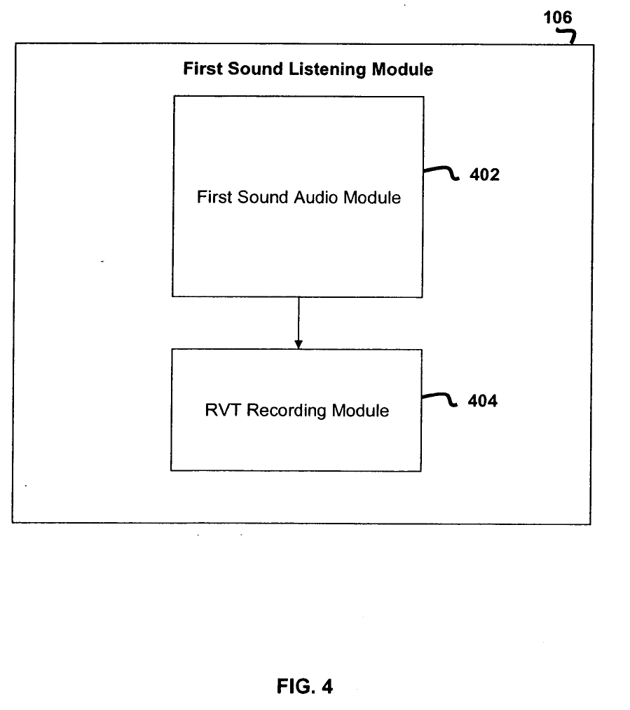

First Sound Listening Module 106 of FIG. 1 receives the first stage sound stimulus from First Sound Stimulus Module 104. First Sound Listening Module 106 enables a user to listen to the verbal stimulus. As shown in FIG. 1, and further described below, First Sound Listening Module 106 is optionally coupled to TICR Module 120, which can provide for timing control and regulation of the first stage sound stimulus being listened to by the user. First Sound Listening Module 106, as shown in the example embodiment of FIG. 4, may include First Sound Audio Module 402 and RVT Recording Module 404 to record the verbal transformations that the Listener-User perceives.

First Sound Audio Module 402 plays the first stage sound stimulus to the Listener-User. First Sound Audio Module 402 may be a computer system, computer component, or other audio system, capable of playing the recorded sequence. In a preferred embodiment, First Sound Audio Module 402 is a computer sound card with a high quality digital to analog converter that retrieves the first stage sound stimulus from memory and plays it to the user through high quality headphones. First Sound Audio Module 402 may alternatively play the recorded first stage sound stimulus through free-standing speakers however this is less preferred as extraneous environmental sound may impair the perception of verbal transformations by the Listener-User.

RVT Recording Module 404 is used to record the verbal transformations that the user perceives as a result of listening to the first stage sound stimulus. Thus, RVT Recording Module 404 may comprise paper and writing utensil, a voice recorder, a computer keyboard, etc., for the Listener-User or an instructor to record the perceived verbal transformations. In a preferred embodiment the Listener-User records the perceived verbal transformations in his or her voice using a microphone. RVT Recording Module 404 may record the verbal transformations perceived by the user during or after listening to the first stage sound stimulus. In the present example where the first stage sound stimulus comprises the root word “flame,” the Listener-User may record RVTs such as “plane,” “explain,” “flane,” “flayed,” etc. RVT Library Module 108 of FIG. 1 receives the RVTs from RVT Recording Module 404 of First Sound Listening Module 106, and stores them in sound RVT Library Module 108.

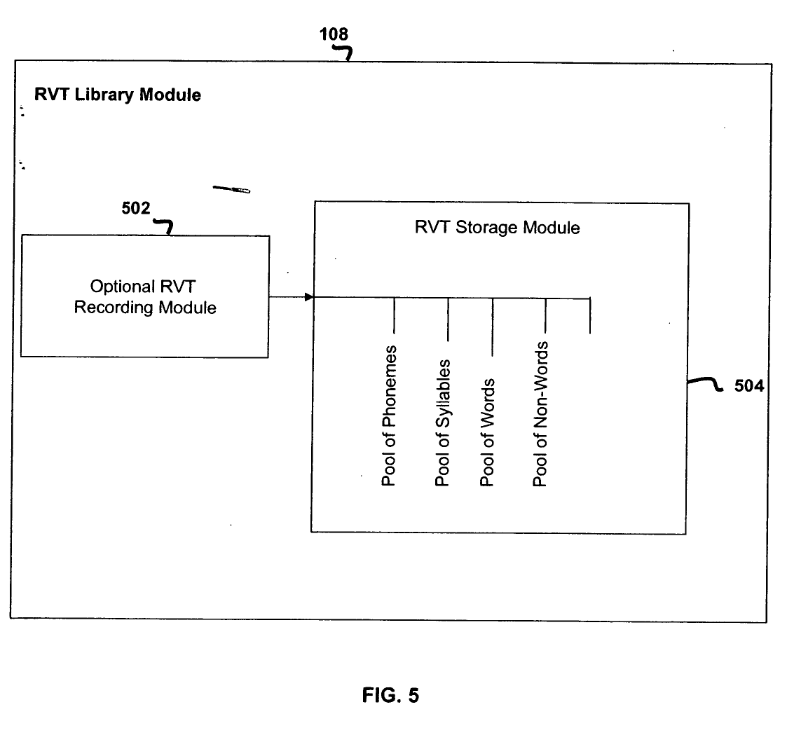

As shown in FIG. 5, RVT library module 108 comprises RVT Storage Module 504 which is used to store the RVTs recorded by RVT Recording Module 404. RVT library module may also comprise Option RVT Recording Module 502, which may be also be used to record verbal transformations by the Listener-User or a performer. RVT Storage Module 504 may include any suitable audio or computer media. RVT Storage Module 504 may utilize the same hardware as sound Storage Module 206 as in the case where the hardware is a computer hard drive. Alternatively, separate hardware may be used as would be necessitated if sound Storage Module 206 comprises read-only media such as an optical disk. In a preferred embodiment, the RVTs are processed in RVT Storage Module 504 prior to storage. The processing includes, removing hiss, removing pauses, and normalizing the loudness. Methods for enhancing the quality of a recording such as an RVT are well known in the art. Sound data required for the database may also be derived from the sound at this time such as duration and spectrotemporal qualities of the sound.

In a preferred embodiment, the RVTs are stored in the form of a relational database. The database associates each RVT with data which specifies the properties of the sound. In one embodiment of a suitable database, the following sound data is included in each record: sound identification number; time of day recorded; circadian phase of performer, verbal; gender of performer; age of performer; fundamental voice frequency of user; identity of user; sound duration; grammatical category (e.g. nouns, verbs, adverbs and non-words); and sound text. The sound data stored in association with each RVT may be utilized during the selection of RVTs for use with the Listener-User and during the second and third stages of the method of the present invention. Over time, as the system is used by a number of subjects or repeatedly by a single subject, the RVT database becomes a useful tool. Analysis of the verbal transformations induced can provide information useful to the optimization of this invention such as identifying preferred root words for particular subjects based upon their age, gender etc. Analysis of the database, by connecting root words and verbal transformations at particular stages of language development, can also provide information regarding the organization of language memory in an individual or population. Analysis of the database by monitoring data acquired during operation of the system by a particular Listener-User, such as frequency and type of illusory verbal transformations recorded, provides an indication of the effectiveness of the system and can be used with other cognitive testing data to allow assessments of the Listener-User's language skills and also monitoring and modification of the system parameters.

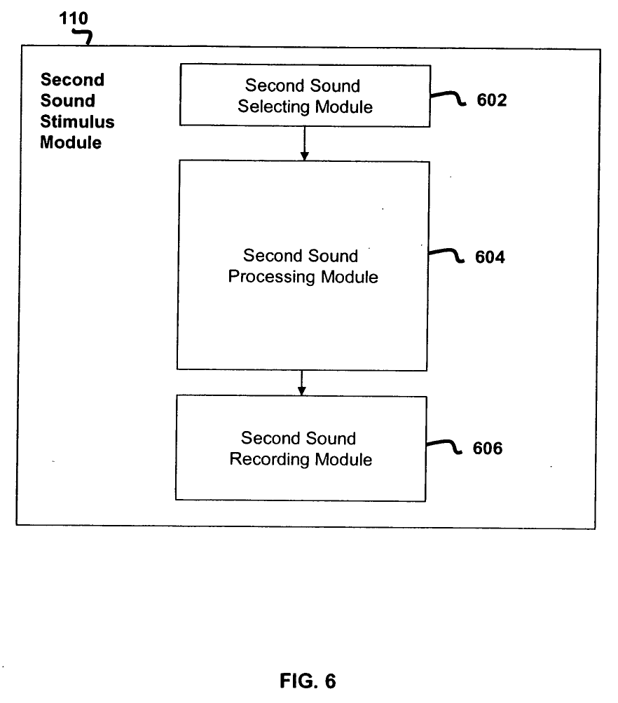

FIG. 6 shows an embodiment of Second Sound Stimulus Module 110. As shown in FIG. 6 Second Sound Stimulus Module 110 may comprise: Second Sound Selecting Module 602; Second Sound Processing Module 604 and Second Sound Recording Module 606. Second Sound Selecting Module 602 accesses the RVTs stored by RVT Library Module 108 and selects RVTs for use in the second stage. Optionally, Second Sound Selecting Module 602 may also access the recorded non-verbal sounds and recorded verbal sounds stored by sound Storage Module 206. It is preferred that Second Sound Selecting Module select RVTs recorded by the current Listener-User from RVT Library Module 108 however more or different words may be required than are stored in RVT Library Module 108. If additional verbal sounds are required in order to satisfy the selection criteria of the second stage and these may be obtained from Sound Library Module 102. Second Sound Stimulus Module 110 optionally is coupled to TICR Module 120, which can provide for timing control and regulation of the repeating sequence.

The criteria of the second stage require that Second Sound Stimulus Module 110 selects a plurality of RVTs that can form a simple phrase or simple sentence. Preferably, the selected phrase or sentence is syntactically complete and semantically meaningful but that is not required. In a simple example the sentence could have the general form “noun verb noun” e.g. “ice is nice.” For the purposes of the second stage it is desirable that the words relate to each in order to simulate semantic context for the words. Second Sound Selecting Module 602 may automatically select the particular recorded verbal transformations, or user interaction may be used to manually select particular recorded verbal transformations. In the present example, Second Sound Selecting Module 602 may select any or all the recorded verbal transformations “plane,” “explain,” and “flayed,” derived from root word “flame.”

Second Sound Processing Module 604 receives selected sounds from Second Sound Selecting Module 602, for processing. For example, Second Sound Processing Module 604 may arrange the selected RVTs into one or more phrases or simple sentences, to be listened by a user. Second Sound Processing Module 604 may define the sequence of RVTs in the phrase or simple sentences and also the number of repetitions of each phrase or simple sentence. For example, Second Sound Processing Module 604 may use the selected RVTs “plane,” “explain,” and “flayed,” derived from the root word “flame” with the verbal sounds “flame” and “the” in a sentence such as “please explain the flayed plane flame.” Furthermore, in an embodiment, Second Sound Processing Module 604 may use one or more selected non-verbal sounds and one of more sound manipulation process to “novel attention process” the sequence of repeating verbal sounds as further described below. Second Sound Processing Module 604 processes the selected sounds and generates the second sound stimulus which includes one or more repetitions of the phrase or simple sentence and optional non-verbal sounds.

Second Sound Recording Module 606 receives the second stage sound stimulus from Second Sound Processing Module 604 and records it. In a preferred embodiment Second Sound Recording Module 606 records the second stage sound stimulus in random access memory for rapid playback. However, Second Sound Recording Module 606 may include any type of audio recording system to record verbal recitation of the phrase/sentence. For example, a human voice may recite the phrase/sentence, which is recorded by Second Sound Recording Module 606. In the example mentioned above, the sentence “please explain the flayed plane flame,” may be recited by the user or a performer, and recorded and stored by Second Sound Recording Module 606. The individual may voice the phrase/sentence with prosodic qualities including normal, soft, imperative, unemotional, emotionally, irritated, commanding, asking, storytelling, crying, and happy. In an alternative embodiment, the processed sounds may be synthesized into a verbal recitation by a computer or other voice synthesis mechanism with or without prosodic intonation, and then stored.

Second Sound Listening Module 112 of FIG. 1 accesses the second stage sound stimulus prepared by Second Sound Stimulus Module 110. Second Sound Listening Module 112 enables a user to listen to the RVTs and other sounds (if any) that form the second stage sound stimulus. Listening to the second stage stimulus provides many benefits to the user. For example, listening to the repeating sequence of verbal transformations combined into a sentence enhances qualitative aspects of holistic auditory perception in a Listener-User. The advantage of the syntactic structure of the second stage stimulus is the addition of context and prosodic effects. Thus, the Listener-User's perception of larger and more complex pieces of speech information is stimulated. Specifically, the second stage sound stimulus acts as a holistic perceptual module, triggering in a Listener-User larger perceptual instabilities. These perceptual instabilities blur the spectral and temporal boundaries among the RVTs used in preparing the second stage sound stimulus, such that new verbal transformations are created. The verbal transformations induced by the second stage stimulus enhance the Listener-User's ability to spontaneously detect and pre-attentively attain comprehension of speech segments larger than single words. This enables enhancements in the Listener-User's ability to listen, read and write.

As shown in FIG. 1, and further described below, Second Sound Listening Module 112 optionally is coupled to TICR Module 120, which can provide for timing control and regulation of the playing of the second stage sound stimulus, including in an interactive or “real-time” manner. Note that in an example embodiment, Second Sound Listening Module 112 may include a Second Sound Audio Module and a Second Sound Recording Module similar to those of First Sound Listening Module 106, as shown in FIG. 4. As with First Sound Listening Module 112 the second stage stimulus may be played through free-standing speakers or through headphones worn by the Listener-User.

Second Sound Stimulus Module 110 and Second Sound Listening Module 112 are provided in embodiments where it is desired for a user to listen to simulated syntactic compounds of RVTs recorded by the user in RVT Library Module 108. In other embodiments, it may be desired for a user to listen to imaginary stories. In such embodiments, Second Sound Stimulus Module 110 and Second Sound Listening Module 112 may not be present, and instead Third Sound Stimulus Module 114 and Third Sound Listening Module 116 may be present. Third Sound Stimulus Module 114 and Third Sound Listening Module 116 may or may not be present in embodiments where it is desired for a user to listen to a syntactic-like grammatical structure such as a phrase(s)/sentence(s) prepared from the user's recorded verbal transformations stored in RVT Library Module 108.

FIG. 7 shows a block diagram of a generic computer system capable of embodying the present invention. The computer system comprises a processor (CPU) 701 coupled to Random Access Memory 703, Hard Drive 704, CD-Rom drive 705, Keyboard 706, Mouse 707, Network Access Hardware, 717, Sound Card 718, and Video Card 708 via one or more Buses 702. Microphone 710 may be used to record the voice of the Listener-User or performer and Stereo Headphones 711 may be used for playing the verbal stimuli to the Listener-User 712. Both the microphone and headphones connect to sound card 718. It is preferred that the sound card be capable of full duplex operation to be able to record audio on its input channel while still playing audio on its output channels. Alternatively, separate audio cards can be used for the input and output audio signals. Video monitor 713 is connected to Video Card 708 and is used for providing instructions and information to the Listener-User 712. As shown in FIG. 7, the computer system of the present invention may include one or more networked computers of which remote computer 716 is an example. Network Access Hardware 717 enables data flow via Network 715, which may be a local area network or a wide area network, to Remote Computer 716.

The computer system preferably includes Monitor hardware 719 for monitoring an intrinsically variable physiological cycle of the Listener-User 712. Monitor hardware 719 preferably includes hardware for monitoring one or more of the Listener-Users, cardiac cycle, breathing cycle, circadian cycle, hormonal cycle, pulse pressure cycle or brainwave activity. Suitable Monitor hardware such is known to those of skill in the art and is also disclosed in inventors' prior U.S. Pat. No. 6,644,976 titled Apparatus, Method And Computer Program Product To Produce Or Direct Movements In Synergic Timed Correlation With Physiological Activity issued Nov. 11, 2003. In a preferred embodiment, Monitor hardware includes a wireless Polar heart monitor system, available from Polar Electro Inc. of New York, N.Y.

The present invention may be implemented in various environments, including combinations of different environments. For example, in embodiments, the present invention may be implemented in one or more computer systems, in one or more audio systems, by one or more humans/individuals, and in any combination thereof. In embodiments, portions of the present invention may be implemented in hardware, software, firmware, and any combination thereof. The invention is also directed to computer program products comprising software stored on any computer useable medium. Such software, when executed in one or more computer systems and other types of data processing devices, causes the computer system and data processing device(s) to operate as described herein. Embodiments of the invention employ any computer useable or readable medium, known now or in the future. Examples of computer useable mediums include, but are not limited to, primary storage devices (for example, any type of random access memories), secondary storage devices (for example, hard drives, floppy disks, compact discs (CDs), ZIP disks, tapes, magnetic storage devices, optical storage devices, micro-electromechanical systems (MEMS), nanotechnological storage devices, etc.), and communication mediums (wired and wireless connections and networks, local area networks, wide area networks, intranets, etc.). Further embodiments, including equivalents, variations, and modifications (including additional or fewer components), will be apparent to persons skilled in the relevant art(s) from the teachings herein.

Third Sound Stimulus Module 114 of FIG. 1 receives RVTs stored by RVT Library Module 108. Third Sound Stimulus Module 114 processes the RVTs to compose a third stage sound stimulus comprising a compilation of RVTs and optionally other recorded verbal sounds and non-verbal sounds to form one or more imaginary stories. The key feature of imaginary stories is an increase in the grammatical complexity of relationship of the words. An imaginary story comprises a plurality of phrases or simple sentences composed into a simulated semantic structure depicting a story. At this third stage it is desired that there be a real or simulated semantic relationship between the various phrases and/or simple sentences.

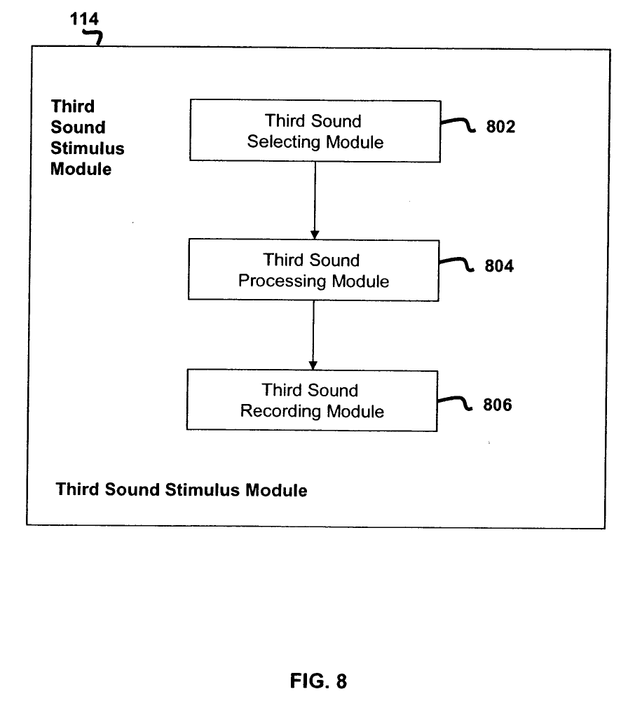

As shown in FIG. 8, Third Sound Stimulus Module 114 may include a Third Sound Selecting Module 802, a Third Sound Processing Module 804, and Third Sound Recording Module 806. Third Sound Selecting Module 802 selects RVTs from RVT Storage Module 504 of RVT Library Module 108. Third Sound Stimulus Module 114 optionally is coupled to TICR Module 120, which can provide for timing control and regulation of the repeating sequence. Third Sound Selecting Module 802 may optionally select one or more verbal sounds or non-verbal sounds from Sound Library Module 102. In the present example, Third Sound Selecting Module 802 may select the RVTs of “plane,” “explain,” and “flayed,” induced by the first stage sound stimulus which included the repeated root word “flame.” Third Sound Selecting Module 802 may automatically select the particular RVTs, or user interaction may be used to manually select particular RVTs suitable to compose the imaginary story.

Third Sound Processing Module 804 receives the phrases from Third Sound Selecting Module 802, and processes the phrases into an imaginary story. The imaginary story does not have to be syntactically complete, but it is desired that the phrases and/or simple sentence relate to each other in some manner and that the form of the imaginary story trigger a semantic closure effect. By way of explanation, whereas RVTs of the first stage might be formed into a noun-verb-noun structure to prepare the second stage-stimulus, similarly phrases of the second stage stimulus may be arranged in a beginning-middle-end structure to prepare an imaginary story for the third stage sound stimulus. Third Sound Processing Module 804 composes an imaginary story from one or more phrases to be listened to by a user. In an embodiment, third stage processing 804 may define the sequencing order of the phrases and the number of times the imaginary story will be repeated for the Listener-User. For example, Third Sound Processing Module 804 may use the sentence “please explain the flayed plane flame” one or more times in an imaginary story along with other phrases or sentences. Furthermore, in an embodiment, Third Sound Processing Module 804 may use one or more selected non-verbal sounds and one of more sound manipulation processes to “novel attention process” the third stage stimulus.

Third Sound Recording Module 806 receives the imaginary story from Third Sound Processing Module 804, and records and stores the imaginary story preferably in random access memory. Alternatively, Third Sound Recording Module 806 may include any type of audio recording system to record the verbal recitation of the imaginary story. The user or a performer may recite the imaginary story, which is recorded by Third Sound Recording Module 806. The user or performer may speak the imaginary story with prosodic qualities including normal, soft, imperative, unemotional, emotional, irritated, commanding, asking, storytelling, and happy. Note that in an alternative embodiment, the imaginary story may be synthesized into a verbal recitation by a computer or other voice synthesis mechanism, with or without intonation, and then stored.

Third Sound Listening Module 116 of FIG. 1 accesses the imaginary stories prepared by Third Sound Stimulus Module 114. Third Sound Listening Module 116 enables a user to listen to the third stage sound stimulus or imaginary story, which may be repeated a selected number of times, or repeated for a particular duration of time. Listening to the third stage sound stimulus provides many benefits to the user. For example, repeated listening to the imaginary story can generally promote a preferential and faster processing in the afferent flow of auditory information across one or more areas of the brain that handle receptive language acquisition. The repetitive listening to imaginary stories enhances holistic auditory perceptual detection of large chunks of speech information resulting in enhanced spontaneous pre-attentive comprehension of entire phrases at once in a Listener-User. Repeated listening to the third stage sound stimulus accomplishes semantic closure via new and novel pathways within receptive language neural networks. Repetitive listening to an imaginary story promotes in a Listener-User strong orienting responses towards detecting novel changes in prosodic information. The result is that the Listener-User's ability to detect and comprehend speech is holistically enhanced.

As shown in FIG. 1, and further described below, Third Sound Listening Module 116 optionally is coupled to TICR Module 120, which can provide for timing control and regulation for the imaginary story being listened to, including in an interactive or “real-time” manner. Note that in an example embodiment, Third Sound Listening Module 116 may include a Third Sound Audio Module and a Third Sound Recording Module, similar to First Sound Listening Module 106, as shown in the example embodiment of FIG. 4. Third Sound Listening Module 116 may play the imaginary story through free-standing speakers and through a set of headphones worn by the user.

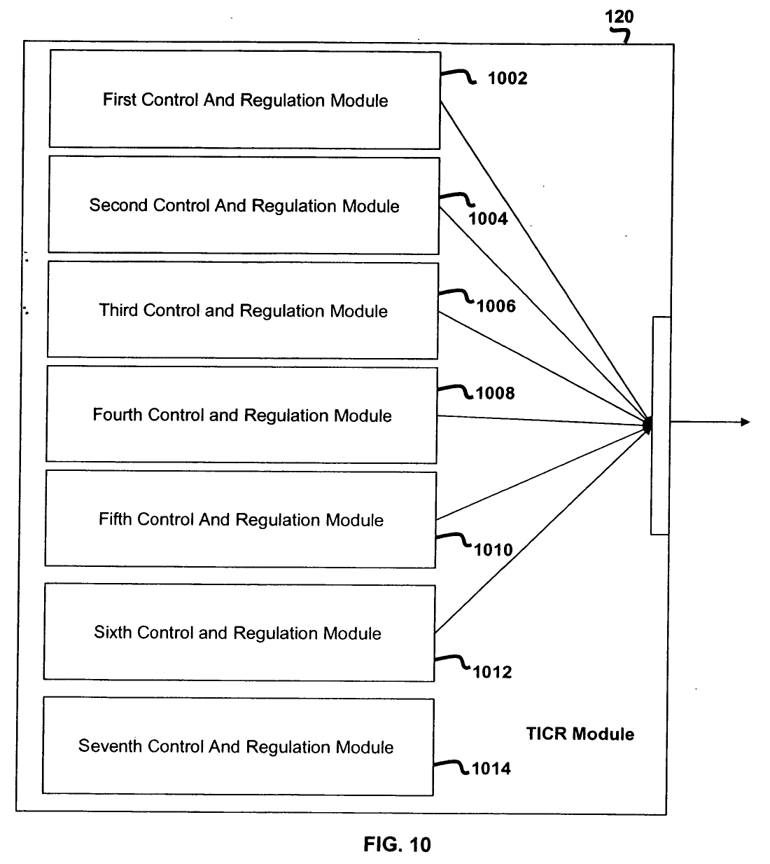

TICR Module 120 of FIG. 1 provides for control and regulation of timing for various features of the present invention. In one embodiment of the present invention, TICR 120 may be used to control access to the other modules of System 100. Access control may be implemented via a menu structure. Access to the various modules may also be programmatically controlled or supervisor controlled. For example, it is preferred that the when the Listener-User first utilizes the system they are limited to the first stage of the system in order to generate sufficient RVTs for creation of the sound stimuli of the second and third stages. Also, depending upon the implementation of the present invention, the Listener-User may be blocked from direct access to Sound Library Module 102, and direct access may be restricted to a supervisor or performer to permit the loading or recording of verbal and non-verbal sounds into the sound library. Furthermore, TICR Module 120 provides for the regulation of the timing of the various parameters in an off-line process during preparation of the sound stimuli and/or in a real-time process while the user listens to the sound stimuli. The real-time process may include real-time adjustments required for example in correlating sound stimuli with intrinsically variable physiological cycles of the Listener-User. TICR Module 120 in controlling timing and other aspects of the sound stimuli may implement some of the features of the novel attention processing techniques described herein. TICR Module 120, as shown in the example embodiment of FIG. 10, may include one or more of a First Control And Regulation Module 1002, a Second Control And Regulation Module 1004, a Third Control And Regulation Module 1006, a Fourth Control And Regulation Module 1008, a Fifth Control And Regulation Module 1010, a Sixth Control And Regulation Module 1012 and a Seventh Control And Regulation Module 1014. Modules 1002, 1004, 1006, 1008, 1010, 1012, and 1014 may be implemented in hardware, software, or firmware. Furthermore, one or more of modules 1002, 1004, 1006, 1008, 1010, 1012, and 1014 may be implemented in the same, different or overlapping portions of hardware/software/firmware.

First Control And Regulation Module 1002, when present, provides for control and regulation of the entire length of time of sounds and a length of time elapsing between consecutive sounds in a sequence of sounds. For example, assume a sound is a word “flame.” First Control And Regulation Module 1002 can vary the length of time that the word “flame” is to be played by a recording. First Control And Regulation Module 1002 is capable of “stretching” the word “flame” (i.e., increasing the length of time needed to play the word), and is capable of compressing the word “flame” (i.e., decreasing the time interval needed to play the word), as desired. Furthermore, assume that the word “flame” is to be repeated, as “flame flame flame . . . . ” First Control And Regulation Module 1002 can vary the length of time that elapses between each repetition of the word “flame”, by decreasing or increasing the time interval between consecutive word repetitions, as desired. First Control And Regulation Module 1002 can vary the total length of the time for playing a sound, and the time interval between repetitions of sounds.

Second Control And Regulation Module 1004, when present, provides for control and regulation of the length of time between sound sequences. For example, assume a first sound sequence is “flame flame flame” and a second sound sequence is “ice ice ice.” Second Control And Regulation Module 1004 can vary the length of time that elapses between the recitations of “flame flame flame” and “ice ice ice,” by decreasing or increasing the length of time interval between them, as desired.

Third Control And Regulation Module 1006, when present, provides for control and regulation of the total time duration of listening to the sound sequence occurring due to operation of First Sound Listening Module 106. For example, a user may listen to a verbal sound sequence where the word “flame” is repeated. Third Control And Regulation Module 1006 can vary the total length of time that the word “flame” is repeated. Alternatively, Third Control And Regulation Module 1006 can vary the number of times that the word “flame” is repeated.

Fourth Control And Regulation Module 1008, when present, provides for control and regulation of the total time duration of listening to the phrases and imaginary stories in operation of Second Sound Listening Module 112 and Third Sound Listening Module 116. For example, during operation of Second Sound Listening Module 112, a user may listen to a combination of words such as “the ice is nice.” Fourth Control And Regulation Module 1008 can vary the total length of time that the phrase/sentence “the ice is nice” is repeated. Alternatively, Fourth Control And Regulation Module 1008 can vary the number of times that the phrase/sentence “the ice is nice” is repeated. Alternatively, during operation of Third Sound Listening Module 116, a user may listen to an imaginary story. Fourth Control And Regulation Module 1008 can vary the total length of time that the imaginary story is repeated. Alternatively, Fourth Control And Regulation Module 1008 can vary the number of times that the imaginary story is repeated.

Fifth Control And Regulation Module 1010, when present, provides for control and regulation of any time delay between the arrival time of sound signals to the left and right ears of the user. As described elsewhere herein, in embodiments of the present invention, verbal sound signals, including speech and recycling of non-verbal sound signals (e.g., music, nature, noise) may be transmitted to the left and right ears of a user, in any temporal order. Fifth Control And Regulation Module 1010 can vary the arrival time of the verbal sounds and non-verbal sounds to the left and right ears, so that they arrive at the same or different times at the left and right ears. For example, the word “flame” may be input to a user's right ear, while the word “ice” is input to the user's left ear. Fifth Control And Regulation Module 1010 can vary the time of arrival of the words, “flame” and “ice” at the respective ears, so that the words occur at the same time, or at different (e.g., offset) times. The words can be offset from each other by a constant offset amount, or by varying offset amounts.

Sixth Control And Regulation Module 1012, when present, provides for control and regulation of the timing sounds (e.g., verbal and non-verbal) to regulate the masking of a sound upon other sounds. For example, the word “flame” may be input to a user's left ear, while a non-verbal sound is input to the user's right ear. Sixth Control And Regulation Module 1012 can vary the timing of recitation (repetition) of the word “flame” in the left ear versus the input of the non-verbal sound to the user's right ear, so that the word “flame” and the non-verbal sound may or may not temporally overlap each other occur. For example, the non-verbal sound may be timed to occur at the same time as the word “flame,” to obscure the word “flame” entirely, or a portion of the word “flame”, to the user. When obscuring a portion of the word “flame”, the recycling of a noise sound can be timed to obscure the same portion, or different portions of the word “flame”. Furthermore, the non-verbal sound can be timed with each occurrence of the repeated word “flame”, every other occurrence of the repeated word “flame”, every three occurrences of the word “flame”, every ten occurrences of the word “flame”, and in any other desired ratio. Alternatively (or concurrently), the non-verbal sound can randomly occur during pre-selected repetitions of the word “flame”. Furthermore, a non-verbal sound can occur multiple times during a word. Thus, obscuring sounds of a word. In a similar fashion as for an entire word, Sixth Control And Regulation Module 1012 can be used to vary the timing of repeated sounds during playing verbal and non-verbal sounds.

Seventh Control And Regulation Module 1014, when present, provides for control and regulation of channel selection for sound signals to the left and right ears of the user. As described elsewhere herein, in embodiments of the present invention, verbal sound signals, including speech and recycling of non-verbal sound signals (e.g., music, nature, noise) may be transmitted to the left and right ears of a user, in any temporal order. Seventh Control And Regulation Module 1014 can switch the left channel audio to the right channel and vice versa.

In particular embodiments, TICR 120 and one or more of modules 1002, 1004, 1006, 1008, 1010, 1012, and 1014 may use one or more of the user's intrinsically variable physiological cycles (e.g., breathing cycle, pulse cycle, brainwave activity and cardiac cycle—including timing with systolic and diastolic cardiac phases) as a reference for timing; and a measure of attention/orienting responses. The attention/orienting response detected in the Listener-User may be used by the system to alter the stimuli in order to achieve the desired level of attention/orienting. The main traits of orienting towards novelty are (a) behavioral quieting; (b) increased parasympathetic activity (c) a brief slowing of heart rate; (d) momentary reduction in skin conductance; and (e) evidence of high-priority (afferent) processing of the eliciting stimulus. Intake of sensory information is facilitated by HR slowing whereas rejection of sensory information is facilitated by HR speeding. The inventors have demonstrated that stimuli can elicit a transient HR slowing by presenting stimuli early in the cardiac cycle (phase synchronized) compared with later stimuli. The magnitude of this cardiac cycle time effect is larger for rare than frequent standard stimuli, suggesting the importance of stimulus novelty and significance. As a consequence, in one embodiment of the present invention TICR 120 receives input from a heart monitor. TICR 120 can use heart beat data received from the heart monitor in order to synchronize the onset of sounds in the sound stimuli with either the diastolic phase or the systolic phase of the cardiac cycle. Further information regarding methods for correlating stimuli with intrinsically variable physiological human cycles can be found in the inventors' prior U.S. Pat. No. 6,644,976 titled Apparatus, Method And Computer Program Product To Produce Or Direct Movements In Synergic Timed Correlation With Physiological Activity issued Nov. 11, 2003 and co-pending U.S. patent application Ser. No. 10/235,838 titled Apparatus, Method And Computer Program Product To Facilitate Ordinary Visual Perception Via An Early Perceptual-Motor Extraction Of Relational Information From A Light Stimuli Array To Trigger An Overall Visual-Sensory Motor Integration In A Subject, filed Sep. 6, 2002.

“Novel attention processing” is the inventors' term for selective and preferential processing of afferent sound stimuli to reduce or delay habituation and promote or sustain orienting to the stimuli. As indicated above, the First Sound Processing Module, Second Sound Processing Module and the Third Sound Processing Module may all perform novel attention processing on selected sounds during preparation of sound stimuli. Novel attention processing may also be conducted in real-time by the interaction of TICR 120 with First Sound Listening Module 106, Second Sound Listening Module 110, and Third Sound Listening Module 116. “Novel attention processing” may be conducted using a range of techniques and may be used in the present invention to promote strong and sustained perception of verbal transformations by the Listener-User. Furthermore, attention and orienting of the user may be monitored using standard techniques and the novel attention processing may be adjusted to increase or decrease attention as required with a particular Listener-User.

One technique used in novel attention processing is masking the verbal stimuli with non-attended noise that momentarily obscures discrete speech elements (e.g. syllables), in the verbal stimulus. Such processing reduces the intelligibility of redundant information available to the listener and thereby prevents or delays semantic closure and habituation while at the same time promoting the verbal transformation effect. In one example of novel attention processing, non-verbal sounds may be used to selectively partially or completely obscure the verbal sounds that the user is listening to. By reducing redundancy in the speech signal selective masking with non-verbal sounds can be used to promote the perception of distinct verbal transformations components by the Listener-User. Selective masking can similarly be used to cause the Listener-User to change orientating thus sustaining greater attention upon semantic closure of verbal content of a phrase(s)/sentence(s). In one embodiment of the invention, the masking noises may be applied in time-varying correlation with an intrinsically variable cyclic physiological activity of the Listener-User.

A second technique of novel attention processing is the use of “timing effects.” For example, masking noise may be used to prime very short-term sensory processes e.g. echoic memory (also known as sensory short memory storage) to scan specifically for percepts depicting sensorial information related to “timing” changes. Noise periodicity change can be used to trigger a holistic auditory illusion which induces the perception of a motorboating or whooshing sound. These perceptual illusions originate from instability rooted in conflicting sound timings. The perception of the timing change elicits a physiological orienting response, triggering a perceptual-motor synergism among many mechanical articulator systems (e.g. heart, respiration, vocal cords, tongue etc,) and perceptual-cognitive processes involved in mediating receptive and expressive language (e.g. attention, memory, expectations etc,). In an embodiment, if non-attended non-verbal sounds are properly timed in association with repetitive verbal stimuli, reciprocal non-linear perturbations can be created between the auditory stimuli.

A third technique of novel attention processing is the use of “position and motion effects.” For example, Doppler audio effects may be used to induce perceptions of sound source movement in the Listener-User, thus the Doppler technique can readily be used to direct orienting. A simple way to achieve this effect is by multiplexing a plurality of audio channels each with a slight difference in time delay. The Doppler and time delay techniques find particular utility in the treatment of stuttering. Perceived sound source position, can also be used to introduce novelty to the audio signal. In the simplest case, this is achieved by switching verbal sounds from one channel to another. However, using four or more channels with surround-sound headphones or virtual surround-sound processing, the perceived position of the sound source can be easily varied by the system. The system can either change the position of a sound source instantaneously or make the sound source appear to move relative to the Listener-User. For examples, the perceived source of the sound can be made to rotate around the Listener-User. The surround-sound system can be used to control the perceived position of the source of both verbal sounds and non-verbal sounds.

A fourth technique of novel attention processing is separate control of the sound stimulus at the left and right audio channels. Verbal transformations can be induced separately in the user listening to left ear audio and right ear audio. This can be achieved either with the same sound stimulus presented dichotically, (i.e. time phase shifted). Or by using different sound stimuli. The sound stimuli may be presented to the Listener-User in several different ways. For example, the verbal sounds and non-verbal sounds may both be presented to the Listener-User through both of their right and left ears (via headphones, for example), or either sound type may only be presented to a single ear. Alternatively, the verbal sounds can be presented to one ear, while the non-verbal sounds are presented to the other ear. For example, the verbal sounds may be presented to the left ear and the non-verbal sounds may be presented to the right ear. For example, this may be done because the left ear/left brain hemisphere processes verbal information more effectively than the right ear/right brain hemisphere. Likewise, the non-verbal sounds are advantageously processed by the right ear/right brain hemisphere. Thus, in the present example, the left ear may hear “please explain the flayed plane flame”, while the right ear may hear of periodic or non-periodic noise sounds, which may be timed to occur during portions of words and during whole words and between words. Novel attention processing can be achieved by controlling the Listener-User's orienting to left and right channels. Often the perception of verbal transformations is increased in an unattended speech channel. In such case changes the unattended stimuli attract attention to those stimuli hence capturing momentarily one's attention away from the attended stimuli. This, synergism among various sources of auditory information will elicit more durable holistic perceptual instabilities, enhancing the effects of the present invention.

A fifth technique of novel attention processing of the sound stimulus utilizes digital signal processing to modulate qualities of the sound stimulus. Sound stimuli qualities that can be modified are pitch, loudness, spectral range, phase, duration etc. Such modulation can be performed in synchronization with particular sounds in the sound stimulus in a manner that simulates prosodic intonation, or the modulation may be applied in time-varying correlation with an intrinsically variable cyclic physiological activity of the Listener-User such as the cardiac cycle.

A sixth technique of novel attention processing utilizes additional verbal cues which are different and in addition to the sound stimuli of the first, second and third stage. The verbal cues can be in the form of instructions to the Listener-User such as “Over here!” or “Listen to the left channel!” or “This way” played in either the left or right audio channel. The verbal cues might be informational or misleading. Informational cues could provide the Listener-User with instructions regarding the operation of the system such as “Now record all the words you heard in the last Stage.” Misleading cues, may be used to violate the Listener-User's expectations thereby promote orienting and attention. An example would be the cue “the sound will end in ten seconds” played to the user 30 seconds before the end of the sound stimulus.

A seventh technique of novel attention processing of the sound stimulus utilizes synchronization or correlation of verbal or non-verbal-sounds with an intrinsically variable physiological cycle of the Listener-User. In one preferred embodiment that intrinsically variable cyclic activity is cardiac activity detected by a heart monitor. Where a heart monitor is used, changes in heart rate variability may also be used to feedback an indicator of attention to the system and allow for adjusting the novel attention processing. In one preferred embodiment the intrinsically variable cyclic activity is breathing activity. In a preferred mode of novel attention processing, verbal sounds applied to the left ear are correlated with the systolic phase of the cardiac cycle to enhance focused attention. In another preferred embodiment non-verbal sounds applied to the right ear are correlated with the diastolic phase of the cardiac cycle to allow enhancement of speech perception under parasympathetic autonomic influence.

Novel attention processing is useful in the present invention to control the Listener-Users attention and orienting processes. The process may be used to enhance or reduce the relevance and novelty of a particular sound to the Listener-User. Novel attention processing can be used on sound stimuli to induce holistic auditory perception and may also be used on standard audio material (for example books on tape, foreign language learning courses, radio and television) to enhance perception of the auditory content. The control of sound relevance and novelty is particular useful in treating conditions such as Autism and neurodegenerative disorders such as Alzheimer's. Such disorders are characterized in some respects by a lack of normal orienting and attention to speech communication. Novel attention processing may be used to increase the attention and orienting of a Listener-User to a verbal stimulus thereby enhancing holistic speech perception and language learning, maintenance and remediation. In a Listener-User with Alzheimer's, for example, novel attention processing can be used to increase the levels of attention and orienting over those that can be achieved in normal speech communication. In combination with the regular exposure to speech incorporated into the system of the present invention the novel attention processing can maintain or even enhance normal holistic speech perception in the subject. The system of the present invention may be used on its own in the treatment of mild impairments or may be used in combination with medical interventions such as the use of pharmaceuticals and neuro-stimulation to remediate impaired cognitive and memory processes.

An optional sound stimuli editing module may be included in the system of the present invention to allow Listener-User interaction in the recording and processing of sound stimuli such as the imaginary story. The sound stimuli editing module may permit the Listener-User to select, RVTs, verbal sounds and non-verbal sounds and also interact in the recording and processing of the sound stimuli. The involvement of the Listener-User in this process generates additional interest in the Listener-User and allows creation of sound stimuli that may have more relevance for the Listener-User. These two effects in combination with a priming effect enhance orienting and attention in the Listener-User while listening to the sound stimuli thereby enhancing the effects of novel attention processing.

In summary, one of the main goals of the present invention is facilitating holistic speech perception. The present invention accomplishes that goal by presenting uninterrupted synthetic repetition of verbal sounds that trigger illusory verbal transformations in a Listener-User. Subsequently, a semantic-like phonological composition of self-generated illusory verbal transformations is produced, so that both lexical and semantic structures in receptive language can be directly targeted via holistic auditory perception strategies. In summary the inventors would like to emphasize the following significant points:

(1) Listening to an uninterrupted synthetic repetition of speech sounds triggers an auditory perception illusion named “verbal transformations” by which new speech sounds are felt as if spontaneously self-generated (e.g. new syllables and words and short sentences are created);

(2) Listening to an uninterrupted synthetic repetition of speech sounds triggers holistic auditory perception instabilities manifested in timing superposition among perceived verbal transformations.;

(3) Due to a cognitive decentralization (satiation effect) triggered by listening to speech repetitions strong shifts of attention can be triggered by the sustained novelty of the signal. Moreover, if orienting responses are sustained long enough, they cause the Listener-User's heart rate to slow down, hence bringing about a mediated cognitive-perceptual retrieval of verbal transformations under parasympathetic dominance;

(4) Listening to synthetic speech repetition triggers illusory verbal transformations, which generate a two-fold source of auditory sensorial information. The informational sources are: 1) a constant flow of conflicting “timing” sensorial information triggered by auditory perceptual instabilities; and 2) a spectrotemporal information of the physical acoustic carrier signal. Where source “1” enhances source “2” uncertainty in a way that results in non-linear perturbations (variability and flexibility) in fluid speech articulation. “1” and “2” synergically reciprocate with each other promoting in a Listener-User the holistic detection and comprehension of receptive language. Consequently, a more durable generation of illusory auditory perceptual instabilities is elicited, triggering strong physiological orienting responses.

While preferred illustrative embodiments of the present invention are described above, it will be obvious to one skilled in the art that various changes and modifications may be made therein without departing from the invention and it is intended that the appended claims cover all such changes and modifications which fall within the true spirit and scope of the invention.

1. A method for enhancing receptive language skills of a subject comprising:
a) preparing a first sound stimulus;
b) playing the first sound stimulus to the subject;
c) inducing the subject to perceive a first verbal transformation different than the first sound stimulus;
d) preparing a second sound stimulus;
e) playing the second sound stimulus to the subject;
f) inducing the subject to perceive a second verbal transformation different than the second sound stimulus; and
g) repeating steps a, b, c, d, e and f sufficient times to enhance the receptive language skills of the subject.

2-102. (canceled)
